(19) United States
(12) Patent Application Publication
(10) Pub. No.: US 2024/0367810 A1
(43) Pub. Date: Nov. 7, 2024

(54) AIRCRAFT COMPRISING AT LEAST ONE FLUID SUPPLY CIRCUIT EQUIPPED WITH AT LEAST ONE SHUTTER WITH AUTOMATIC CLOSURE

(71) Applicants: Airbus SAS, BLAGNAC (FR); Airbus Operations SAS, TOULOUSE (FR)

(72) Inventors: Philippe MOGILKA, BLAGNAC (FR); Lionel CZAPLA, TOULOUSE (FR)

(21) Appl. No.: 18/653,407

(22) Filed: May 2, 2024

(30) Foreign Application Priority Data
May 4, 2023 (FR) 2304473

(51) Int. Cl. B64D 37/00; B64D 37/30; F02C 7/22

(52) U.S. Cl. CPC B64D 37/005; F02C 7/22; B64D 37/30; F05D 2260/607

(57) ABSTRACT

An aircraft with at least one engine system, at least one zone for ejection of debris originating from the engine system and at least one fluid supply circuit. The latter comprises a shutter configured to occupy open and closed states, at least one return element configured to push the shutter to the closed state and at least one control positioned at least partially in the ejection zone and configured to hold the shutter in the open state against the return element. When the control is broken in the case of an accident, it no longer holds the shutter, which switches automatically to the closed state.

### CROSS-REFERENCES TO RELATED APPLICATIONS

This application claims the benefit of French Patent Application Number 2304473 filed on May 4, 2023, the entire disclosure of which is incorporated herein by way of reference.

### FIELD OF THE INVENTION

The present application relates to an aircraft comprising at least one fluid supply circuit equipped with at least one shutter with automatic closure.

### BACKGROUND OF THE INVENTION

According to one embodiment, an aircraft comprises several propulsion assemblies each comprising a nacelle and an engine system operating with hydrogen, positioned in the nacelle. The aircraft also comprises at least one hydrogen tank and, for each engine system, at least one hydrogen supply circuit linking the hydrogen tank and the engine system.

Each engine system comprises a debris ejection zone in which debris originating from the engine system in the event of accidents can be ejected.

According to one configuration, the hydrogen supply circuit passes through the debris ejection zone. In this case, it is necessary to provide shields positioned in the debris ejection zone, between the engine system and the hydrogen supply circuit, in order to prevent the debris ejected from the engine system from striking the hydrogen supply circuit. This configuration is unsatisfactory because it causes the weight of the aircraft to be increased.

### SUMMARY OF THE INVENTION

The present invention aims to remedy all or part of the drawbacks of the prior art.

To this end, the subject of the invention is an aircraft comprising at least one engine system, at least one zone for ejection of debris originating from the engine system and at least one fluid supply circuit comprising at least one duct channeling a fluid in a direction of flow from upstream to downstream, positioned at least partially in the ejection zone.

According to the invention, the fluid supply circuit comprises at least one shutter positioned in a first duct upstream of the ejection zone and configured to occupy an open state in which the shutter allows the fluid to flow in the first duct and a closed state in which the shutter prevents the fluid from flowing in the first duct, at least one return element configured to push the shutter to the closed state as well as at least one control positioned at least partially in the ejection zone and configured to occupy a first state, called intact state, in which the control holds the shutter in the open state against the return element and a second state, called broken state, in which the control ceases to hold the shutter.

When debris breaks the control, the shutter is no longer held in the open state by the control and automatically and immediately switches over to the closed state. Thus, it is possible to place a part of the fluid supply circuit in the ejection zone while maintaining a high level of safety, without significantly increasing the weight of the aircraft.

According to another feature, the shutter comprises a seat which has a through-orifice channelling the fluid and a movable element configured to be displaced in the direction of flow between a position separated from the seat which corresponds to the open state of the shutter and a position in contact with the seat which corresponds to the closed state of the shutter.

According to another feature, the return element is positioned in the first duct which comprises a shoulder at a distance from the seat, the return element being a compression spring having a first end in contact with the movable element and a second end in contact with the shoulder of the first duct.

According to another feature, the control comprises at least one rod positioned in a second duct of the fluid supply circuit, at least one first stop secured to the rod, at least one second stop secured to the second duct and at least one sliding link linking the rod and the second duct and allowing a translation of the rod in the second duct in the direction of flow. In addition, the rod, the first and second stops and the seat are configured such that, in the first state of the control, the first stop, secured to the rod, is in contact with the second stop, secured to the duct, and that the rod is in contact with the movable element of the shutter and holds it in a position separated from the seat.

According to another feature, the second duct is partially positioned in the ejection zone and extends between first and second ends positioned on either side of the ejection zone.

According to another feature, the ejection zone is delimited by first and second surfaces, the control comprising first and second sliding links positioned respectively at the first and second surfaces delimiting the ejection zone.

According to another feature, the first and second ducts have first and second joining planes pressed against one another when the first and second ducts are linked, the first duct being positioned upstream of the second duct. In addition, the control comprises at least one part positioned protruding with respect to the second joining plane of the second duct and configured to penetrate into the first duct in order to push the shutter to the open state.

According to another feature, the control comprises first and second sliding links, the second sliding link, the furthest away from the first end, ensuring the second stop function, the first stop being positioned between the first and second sliding links.

### BRIEF DESCRIPTION OF THE DRAWINGS

Other features and advantages will emerge from the following description of the invention, a description given purely by way of example, in light of the attached drawings in which:

FIG. 1 is a perspective view of an aircraft,

FIG. 2 is a schematic representation of a part of a propulsion assembly illustrating an embodiment of the invention,

FIG. 3 is a schematic representation of a part of a fluid supply circuit, equipped with a shutter with automatic closure in the open state, illustrating an embodiment of the invention,

FIG. 4 is a schematic representation of the part of the supply circuit visible in FIG. 3 before the assembly thereof,

FIG. 5 is a schematic representation of the part of the supply circuit visible in FIG. 3 at the moment when it is cut by debris, the shutter with automatic closure being still in the open state,

FIG. 6 is a schematic representation of the part of the supply circuit visible in FIG. 3 cut by debris, the shutter with automatic closure being in the closed state.

### DETAILED DESCRIPTION OF THE PREFERRED EMBODIMENTS

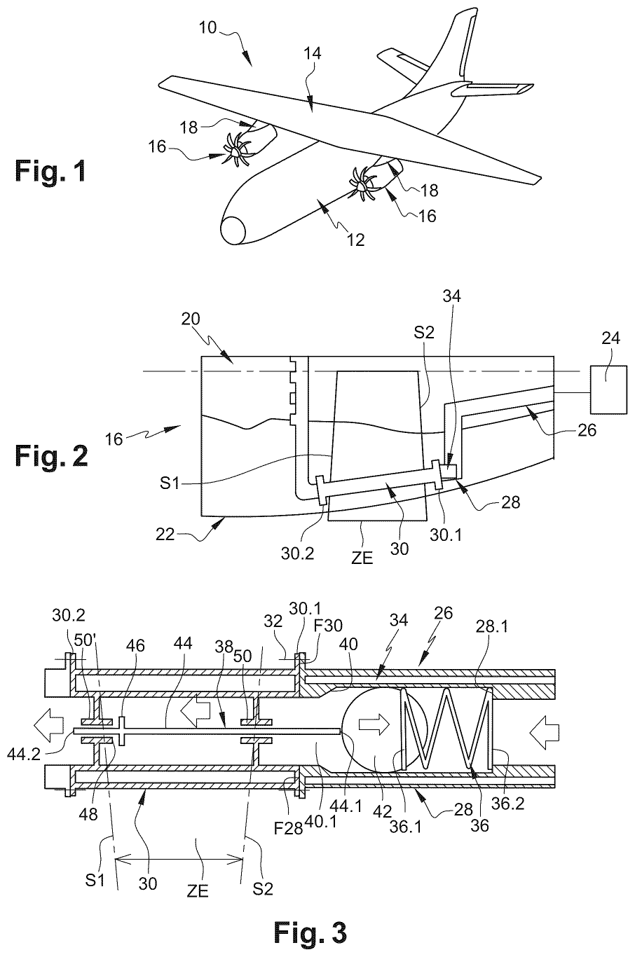

According to an embodiment visible in FIG. 1, an aircraft 10 comprises a fuselage 12, a wing structure 14 and at least one propulsion assembly 16 positioned under the wing structure 14 and linked thereto by a pylon 18. As illustrated in FIG. 2, the propulsion assembly 16 comprises an engine system 20 using hydrogen, such as a hydrogen turbojet engine or an electric motor powered by fuel cells for example, and a nacelle 22 which forms a fairing surrounding the engine system 20.

The aircraft comprises at least one zone ZE for ejection of debris coming from the engine system 20 in which debris can be ejected in case of accidents, such as debris from a turbine disc for example. Each ejection zone ZE is delimited by first and second surfaces S1, S2.

The aircraft 10 also comprises at least one hydrogen tank 24 positioned in the fuselage 12 and/or the wing structure 14 and, for each propulsion assembly 16, at least one hydrogen supply circuit 26 linking the hydrogen tank 24 and the engine system 20.

According to one embodiment, the hydrogen supply circuit 26 comprises several double-skin ducts 28, 30 configured to channel the hydrogen, disposed end-to-end and linked pairwise by at least one link element 32, at least one of said ducts 28, 30 being situated at least partially in the ejection zone ZE.

Obviously, the invention is not limited to this application. Whatever the embodiment, the aircraft 10 comprises at least one fluid supply circuit 26 comprising at least one duct 28, 30 positioned at least partially in the ejection zone ZE. Although illustrated with double-skin ducts, the invention is in no way limited to this type of duct, which can be a single-wall duct.

Hereinafter in the description, the terms upstream/downstream refer to the direction of flow of the fluid in the supply circuit 26, which flows in a direction of flow from upstream to downstream.

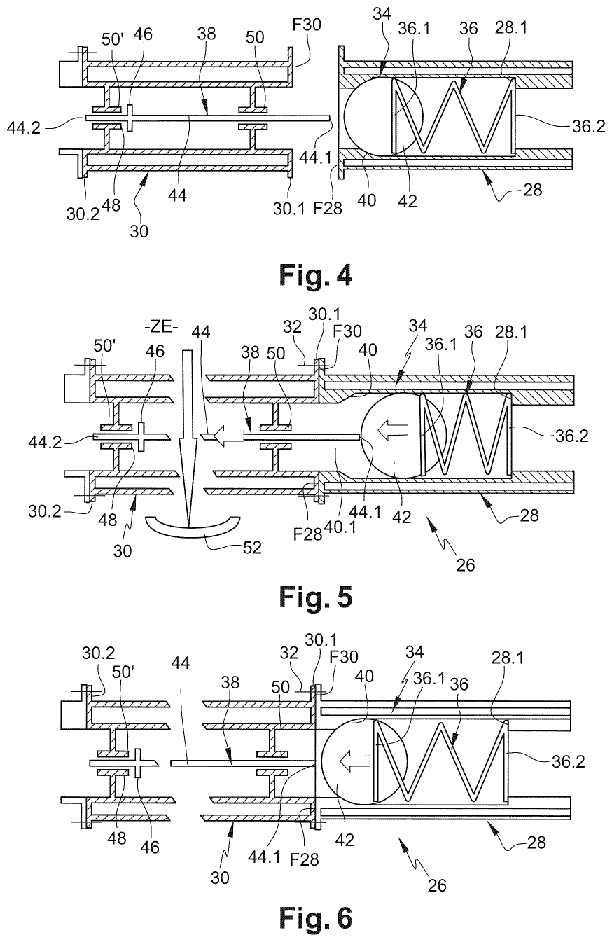

The fluid supply circuit 26 comprises at least one shutter 34 positioned in a first duct 28, upstream of the ejection zone ZE, and configured to occupy an open state (visible in FIGS. 3 and 5) in which the shutter 34 allows the fluid to flow in the first duct 28 and a closed state (visible in FIGS. 4 and 6) in which the shutter 34 prevents the fluid from flowing in the first duct 28, at least one return element 36 configured to push the shutter 34 to the closed state and at least one control 38 positioned at least partially in the ejection zone ZE and configured to occupy a first state, called intact state, in which the control 38 holds the shutter 34 in the open state against the return element 36 and a second state, called broken state, in which the control 38 ceases to hold the shutter 34, which switches automatically to the closed state by virtue of the return element 36. The return element 36 then exerts its return force on the shutter 34, which makes it possible to hold the shutter 34 in the closed state.

According to one construction, the shutter 34 is positioned in a first duct 28 and the control 38 is positioned in a second duct 30.

According to one embodiment, the shutter 34 comprises a seat 40, secured to the first duct 28, which has a through-orifice 40.1 channeling the fluid and a movable element 42, such as a sphere for example, positioned in the first duct 28 and movable in the direction of flow between a position separated from the seat 40 which corresponds to the open state of the shutter 34 and a position in contact with the seat 40 which corresponds to the closed state of the shutter 34. According to one construction, the seat 40 corresponds to a reduction of section of passage of the first duct 28. The seat 40 and the movable element 42 are configured such that, when the movable element 42 is in contact with the seat 40, it tightly shuts the through-orifice 40.1. The through-orifice 40.1 is substantially (i.e., +\−10%) centered with respect to the first duct 28.

According to one embodiment, the return element 36 is positioned in the first duct 28, which comprises a shoulder 28.1 at a distance from the seat 40. According to one construction, the movable element 42 is positioned between the return element 36 and the seat 40 and the return element 36 is situated between the movable element 42 and the shoulder 28.1 of the first duct 28. According to one configuration, the return element 36 is a compression spring which has a first end 36.1 in contact with the movable element 42 and a second end 36.2 in contact with the shoulder 28.1 of the first duct 28.

According to one embodiment, the control 38 comprises at least one rod 44, positioned in the second duct 30, substantially rectilinear, which extends between first and second ends 44.1, 44.2, at least one first stop 46 secured to the rod 44, at least one second stop 48 secured to the second duct 30 and at least one sliding link 50 linking the rod 44 and the second duct 30 and allowing a translation of the rod 44 in the second duct 30 in the direction of flow, the first end 44.1 of the rod 44 being oriented towards the shutter 34. The rod 44, the first and second stops 46, 48 and the seat 40 are configured such that, in the first state of the control 38 (the rod 44 being intact), the first stop 46, secured to the rod 44, is in contact with the second stop 48, secured to the second duct 30, and that the first end 44.1 of the rod 44 is in contact with the movable element 42 of the shutter 34 and holds it in a position separated from the seat 40 against the efforts exerted by the return element 36.

The control 38 comprises two sliding links 50, 50′ that are spaced apart, configured such that the rod 44 is substantially coaxial to the second duct 30.

According to one construction, the shutter 34 is positioned upstream of the control 38. The return element 36 is positioned upstream of the movable element 42 which is itself positioned upstream of the seat 40.

According to one configuration, the second duct 30 is partially positioned in the ejection zone ZE and extends between first and second ends 30.1, 30.2 positioned on either side of the ejection zone ZE. The first duct 28 is situated outside of the ejection zone ZE, upstream of this zone. According to this configuration, the first and second sliding links 50, 50′ are positioned respectively in proximity to the first and second ends 30.1, 30.2 of the second duct 30, respectively at the first and second surfaces S1, S2. The second duct 30 could be positioned outside of the nacelle 22 in a dedicated compartment.

According to one construction, the first end 30.1 of the second duct 30 is oriented towards the shutter 34. The second sliding link 50′, the furthest away from the first end 30.1, ensures the second stop 48 function, the first stop 46 being positioned between the first and second sliding links 50, 50′.

According to one embodiment, the first and second ducts 28, 30 have first and second joining planes F28, F30 pressed against one another when the first and second ducts 28, 30 are linked. When the control 38 is in the intact state, at least a part of this control 38, more particularly the first end 44.1 of its rod 44, is positioned protruding with respect to the second joining plane F30 of the second duct 30 and configured to penetrate into the first duct 28 in order to push the shutter 34 to the open state.

The principle of operation of the shutter 34 is described in light of FIGS. 3 to 6. Before being assembled, the first and second ducts 28, 30 are spaced apart. The first end 44.1 of the rod 44 is protruding with respect to the second joining plane F30 of the second duct 30. The movable element 42 is pressed against the seat 40 by the return element 36.

When the first and second ducts 28, 30 are assembled, the first stop 46 of the rod 44 is in contact with the second stop 48, secured to the second duct 30, and the first end 44.1 of the rod 44 pushes the movable element 42 into its separated position against the return element 36.

In operation, when the control 38 is in the intact state, the shutter 34 is in the open state, as illustrated in FIG. 3.

In the event of an accident, debris 52 can damage the second duct 30 and break the rod 44 of the control 38, which switches to the broken state.

When the rod 44 is broken, the part of the rod 44 comprising its first end 44.1 is no longer held by the second stop 48, secured to the second duct 30. Consequently, the movable element 42 no longer being held by the rod 44, the return element 36 pushes it against the seat 40, automatically provoking the switching of the shutter 34 to the closed state. By virtue of this shutter with automatic closure, it is possible to position a part of the fluid supply circuit in the ejection zone ZE without it being necessary to reinforce it and/or provide shields. This solution makes it possible to optimize the weight of the aircraft. If the duct situated in the ejection zone ZE is broken by debris ejected from the engine system 20, the shutter 34 automatically and immediately cuts off the supply of fluid.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
at least one engine system,
at least one ejection zone for ejecting debris coming from the at least one engine system,
at least one fluid supply circuit comprising:
at least first and second ducts which channel a fluid in a direction of flow from upstream to downstream and positioned at least partially in the at least one ejection zone,
at least one shutter positioned in the first duct upstream of the at least one ejection zone and configured to occupy an open state in which the at least one shutter allows the fluid to flow in the first and second ducts and a closed state in which the at least one shutter prevents the fluid from flowing in the first and second ducts, the at least one shutter comprising:
a seat which has a through-orifice channeling the fluid,
a movable element configured to be displaced in the direction of flow between a position separated from the seat which corresponds to the open state of the at least one shutter and a position in contact with the seat which corresponds to the closed state of the at least one shutter,
at least one return element configured to push the at least one shutter to the closed state,
at least one control positioned at least partially in the at least one ejection zone and configured to occupy a first state in which the at least one control holds the at least one shutter in the open state against the at least one return element and a second state in which the at least one control ceases to hold the at least one shutter, the at least one control comprising:
at least one rod positioned in the second duct,
at least one first stop secured to the at least one rod,
at least one second stop secured to the second duct,
at least one sliding link linking the at least one rod and the second duct and allowing the at least one rod to be translated in the direction of flow,
the at least one rod, the at least one first and second stops, and the seat being configured such that, in the first state of the at last one control, the at least one first stop, secured to the at least one rod, is in contact with the at least one second stop, secured to the second duct, and wherein the at least one rod is in contact with the movable element of the at least one shutter and holds the at least one in a position separated from the seat.

2. The aircraft according to claim 1, wherein at least one the return element is positioned in the first duct, which comprises a shoulder at a distance from the seat, and
wherein the at least one return element comprises a compression spring which has a first end in contact with the movable element and a second end in contact with the shoulder of the first duct.

3. The aircraft according to claim 1, wherein the second duct is partially positioned in the at least one ejection zone and extends between first and second ends positioned on either side of the at least one ejection zone.

4. The aircraft according to claim 3, wherein the at least one ejection zone is delimited by first and second surfaces, and
wherein the at least one control comprises first and second sliding links positioned respectively at the first and second surfaces delimiting the at least one ejection zone.

5. The aircraft according to claim 1, wherein the first duct is positioned upstream of the second duct,
wherein the first and second ducts have first and second joining planes pressed against one another when the first and second ducts are linked, and
wherein the at least one control comprises at least a part positioned protruding with respect to the second joining plane of the second duct and configured to penetrate into the first duct in order to push the at least one shutter to the open state.

6. The aircraft according to claim 1, wherein the at least one control comprises first and second sliding links, the second sliding link, the furthest away from a first end and ensuring the at least one second stop functions, the at least one first stop being positioned between the first and second sliding links.
